(19) United States
(12) Patent Application Publication
(10) Pub. No.: US 2025/0218149 A1
(43) Pub. Date: Jul. 3, 2025

(54) IMAGE SEGMENTATION LABEL EXPANSION FOR SELECTED CLASSES

(71) Applicant: GM Cruise Holdings LLC, San Francisco, CA (US)

(72) Inventors: Pranay Agrawal, San Jose, CA (US); Tao Xu, Sunnyvale, CA (US)

(73) Assignee: GM Cruise Holdings LLC, San Francisco, CA (US)

(21) Appl. No.: 18/401,869

(22) Filed: Jan. 2, 2024

(51) Int. Cl. G06V 10/26; G06T 3/40; G06V 10/34; G06V 10/764; G06V 10/774; G06V 20/58; G06V 20/70

(52) U.S. Cl. CPC G06V 10/267; G06T 3/40; G06V 10/34; G06V 10/764; G06V 10/774; G06V 20/58; G06V 20/70

(57) ABSTRACT

An apparatus for facilitating image segmentation on a dataset comprising a plurality of classes is described and includes a module executable by a processor to preprocess the dataset by applying a filter to labels of the plurality of classes to expand the labels of the selected class; down-sample the preprocessed dataset to a desired resolution for training an image segmentation model; and output the down-sampled preprocessed dataset to the image segmentation module, wherein the labels comprise one-hot labels.

### TECHNICAL FIELD

The present disclosure relates generally to image processing in connection with autonomous vehicles (AVs) and, more specifically, to image segmentation label expansion for selected classes having particular application in AV-related image processing.

### BACKGROUND

### Introduction

An AV is a motorized vehicle that can navigate without a human driver. An exemplary AV can include various sensors, such as a camera sensor, a light detection and ranging (LIDAR) sensor, and a radio detection and ranging (RADAR) sensor, among others. The sensors collect data and measurements that the AV can use for operations such as navigation. The sensors can provide the data and measurements to an internal computing system of the AV, which can use the data and measurements to control a mechanical system of the AV, such as a vehicle propulsion system, a braking system, or a steering system. Typically, the sensors are mounted at fixed locations on the AVs.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate AV dispatch and operations, according to some aspects of the disclosed technology;

FIG. 2 illustrates a simplified block diagram of a system for training an image segmentation model, according to some aspects of the disclosed technology;

FIG. 3 illustrates a flow diagram of example techniques for performing image segmentation label expansion for selected classes, according to some aspects of the disclosed technology;

FIGS. 4 and 5 illustrate flow diagrams of example techniques for performing image segmentation label expansion for selected classes according to some aspects of the disclosed technology;

FIGS. 6A-6D illustrate annotated images illustrating example techniques for performing image segmentation label expansion for select classes according to some aspects of the disclosed technology; and

FIG. 7 illustrates an example processor-based system with which some aspects of the disclosed technology can be implemented.

### DETAILED DESCRIPTION

### Overview

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Given the numerous advantages of ride hail, rideshare, and delivery services (which services may be collectively and/or interchangeably referred to herein simply as “rideshare services” whether for a single user/passenger, multiple users/passengers, and/or one or more items for delivery) provided by AVs, it is anticipated that AV rideshare services will soon become the ubiquitous choice for various user transportation and delivery needs, including but not limited to school commutes, airport transfers, long distance road trips, and grocery and restaurant deliveries, to name a few.

One goal of AV systems is to mimic and/or approximate human driving as closely and as safely as possible. One reason for this is that as AVs share the road with vehicles operated by humans, those human operators, who may or may not be aware of the fact that another vehicle is a driverless AV, will expect certain behaviors from the AV. Causing AVs to operate in a manner similar to vehicles controlled by humans increases safety on the road.

Image segmentation involves dividing an image into multiple segments, with each pixel of the image labeled with a class, such as “vehicle” or “pedestrian,” for example. Image segmentation involves converting an image into a collection of regions of pixels that are represented by a mask or a labeled image. By dividing an image into segments, it is possible to process only the important segment(s) of the image rather than the entire image.

There are a variety of techniques for performing image segmentation, but a common method is to use a deep learning model, which may be implemented using a convolutional neural network (CNN), for example.

Environmental perception is an important aspect of autonomous driving and provides critical information about the driving domain to assist in identifying clear driving areas and surrounding obstacles. Image segmentation, and particularly semantic segmentation, is a widely used perception method for AVs for associating pixels of an image with a predefined class.

Deep learning models, such as CNNs, may be trained to predict object boundaries on new images using training datasets comprising images with object boundaries and corresponding labels already annotated. In particular embodiments, images comprising training datasets must be preprocessed. Preprocessing may include one or more of rescaling (or down-scaling), cropping, and/or normalizing of images. Preprocessed images may then be used to train a deep learning model. In particular, the training set of images may be input to the model and the model weights are adjusted to predict the accuracy of the training images' labels. Testing data may be input to and processed by the trained model to evaluate the performance thereof. Once the model has been trained and tested, it can be used to predict the labels of new images.

Image segmentation can be used to improve the accuracy of deep learning models. For example, by partitioning an image into semantically relevant regions, the model can be better trained to recognize objects in images. Additionally, image segmentation can be used to reduce the amount of data that must be processed by the model, which can speed up training and inference.

Labeling data for training deep learning models may be challenging, as there are a variety of techniques for enabling training models to learn from training datasets. Image annotation is a method for annotating images containing objects of interest to make them recognizable to a model. Image annotation, such as semantic segmentation, is a labor-intensive technique that requires pixel-level accuracy. In semantic segmentation, each pixel in an image belongs to a single class. In some implementations, to annotate an image in semantic segmentation, an annotator outlines an object of interest using a tool, such as a pen tool, for example, and labels the object with the appropriate class (e.g., passenger, vehicle, road, etc.). Such label data, comprising a label map, may be used as training data for training a deep learning model as discussed above.

In image segmentation for AV-related images, some classes of objects, such as caution tape (CT) and firehose (FH), for example, are quite narrow and directly down-sampling the corresponding labels for model training leaves just a few (if any) pixels remaining in the labels, which is insufficient for training purposes. This also leads to poor metrics when comparing the performance of the model to predictions.

In accordance with features of particular embodiments described herein, image segmentation label expansion may be performed for select, particularly rare (e.g., FH and CT), classes to avoid the aforementioned issues associated with direct down-sampling. In particular, Gaussian smoothing is applied on the one-hot labels to smooth scores across classes. The per-class scores are weighted by an inverse of their frequency in whole ground truth (GT) datasets, with rare classes thereby being more heavily weighted. Next, the score maps are down-sampled to the required resolution (i.e., the resolution required by the deep learning model), at which point they may be converted to one-hot labels based the new Gaussian scores. Alternatively, in some embodiments, rather than converting the smooth labels to one-hot labels, the smooth labels themselves may be used directly.

In accordance with features of alternative embodiments described herein, image segmentation label expansion may be performed using a dilation function to augment the label maps of select classes, such as FH and CT, for training. The dilation function may be applied once or numerous time depending on the dilation sought to be achieved.

The following detailed description presents various descriptions of specific certain embodiments. However, the innovations described herein can be embodied in a multitude of different ways, for example, as defined and covered by the claims and/or select examples. In the following description, reference is made to the drawings, in which like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the drawings, a particular number and arrangement of structures and components are presented for illustrative purposes and any desired number or arrangement of such structures and components may be present in various embodiments. Further, the structures shown in the figures may take any suitable form or shape according to material properties, fabrication processes, and operating conditions. For convenience, if a collection of drawings designated with different letters are present (e.g., FIGS. 10A-10C), such a collection may be referred to herein without the letters (e.g., as “FIG. 10”). Similarly, if a collection of reference numerals designated with different letters are present (e.g., 110a-110e), such a collection may be referred to herein without the letters (e.g., as “110”).

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y. The terms “substantially,” “close,” “approximately,” “near,” and “about,” generally refer to being within +/−20% of a target value (e.g., within +/−5 or 10% of a target value) based on the context of a particular value as described herein or as known in the art.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Other features and advantages of the disclosure will be apparent from the following description and the claims.

### Example AV Management System

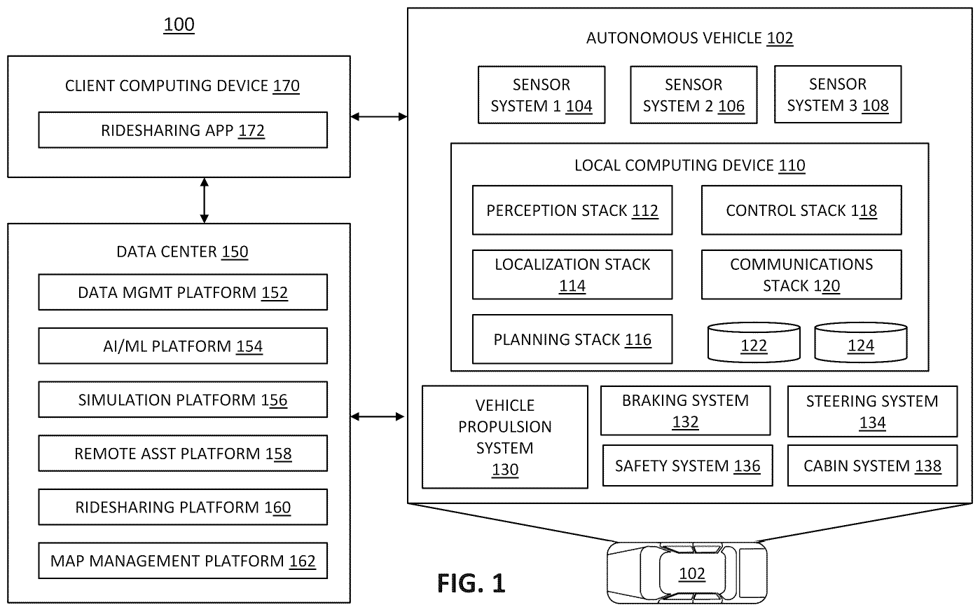

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (Saas) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 102 can navigate about roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

AV 102 can also include several mechanical systems that can be used to maneuver or operate AV 102. For instance, the mechanical systems can include vehicle propulsion system 130, braking system 132, steering system 134, safety system 136, and cabin system 138, among other systems. Vehicle propulsion system 130 can include an electric motor, an internal combustion engine, or both. The braking system 132 can include an engine brake, a wheel braking system (e.g., a disc braking system that utilizes brake pads), hydraulics, actuators, and/or any other suitable componentry configured to assist in decelerating AV 102. The steering system 134 can include suitable componentry configured to control the direction of movement of the AV 102 during navigation. Safety system 136 can include lights and signal indicators, a parking brake, airbags, and so forth. The cabin system 138 can include cabin temperature control systems, in-cabin entertainment systems, and so forth. In some embodiments, the AV 102 may not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a planning stack 116, a control stack 118, a communications stack 120, a High Definition (HD) geospatial database 122, and an AV operational database 124, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 122, other components of the AV, and other data sources (e.g., the data center 150, the client computing device 170, third-party data sources, etc.). The perception stack 112 can detect and classify objects and determine their current and predicted locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth.

Mapping and localization stack 114 can determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 can compare sensor data captured in real-time by the sensor systems 104-108 to data in the HD geospatial database 122 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The planning stack 116 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, DPVs, etc.), traffic rules and other safety standards or practices for the road, user input, and other relevant data for directing the AV 102 from one point to another. The planning stack 116 can determine multiple sets of one or more mechanical operations that the AV 102 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 116 can select from multiple backup plans to carry out. For example, while preparing to change lanes to turn right at an intersection, another vehicle may aggressively cut into the destination lane, making the lane change unsafe. The planning stack 116 could have already determined an alternative plan for such an event, and upon its occurrence, help to direct the AV 102 to go around the block instead of blocking a current lane while waiting for an opening to change lanes.

The control stack 118 can manage the operation of the vehicle propulsion system 130, the braking system 132, the steering system 134, the safety system 136, and the cabin system 138. The control stack 118 can receive sensor signals from the sensor systems 104-108 as well as communicate with other stacks or components of the local computing device 110 or a remote system (e.g., the data center 150) to effectuate operation of the AV 102. For example, the control stack 118 can implement the final path or actions from the multiple paths or actions provided by the planning stack 116. This can involve turning the routes and decisions from the planning stack 116 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 122 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

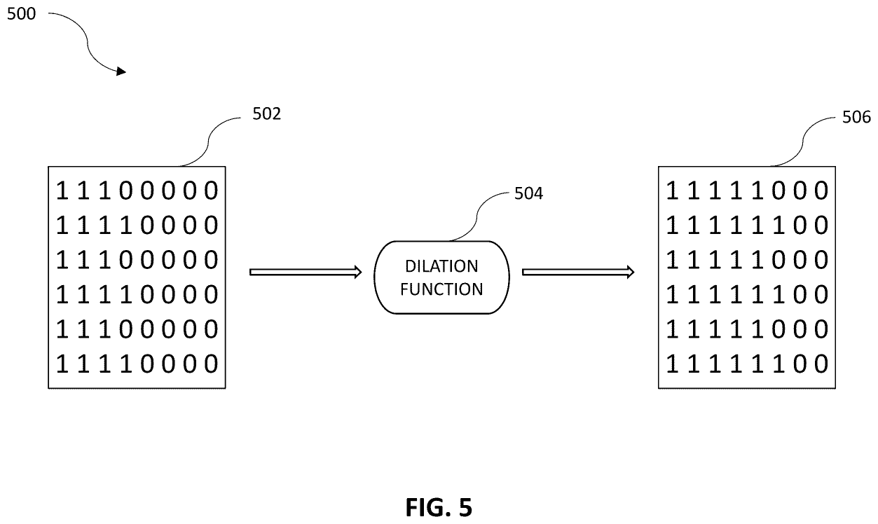

The AV operational database 124 can store raw AV data generated by the sensor systems 104-108 and other components of the AV 102 and/or data received by the AV 102 from remote systems (e.g., the data center 150, the client computing device 170, etc.). In some embodiments, the raw AV data can include HD LIDAR point cloud data, image or video data, RADAR data, GPS data, and other sensor data that the data center 150 can use for creating or updating AV geospatial data as discussed further below with respect to FIG. 5 and elsewhere in the present disclosure.

The data center 150 can be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes one or more of a data management platform 152, an Artificial Intelligence/Machine Learning (AI/ML) platform 154, a simulation platform 156, a remote assistance platform 158, a ridesharing platform 160, and a map management platform 162, among other systems.

Data management platform 152 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare datasets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to be picked up or dropped off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

### Example Image Segmentation System

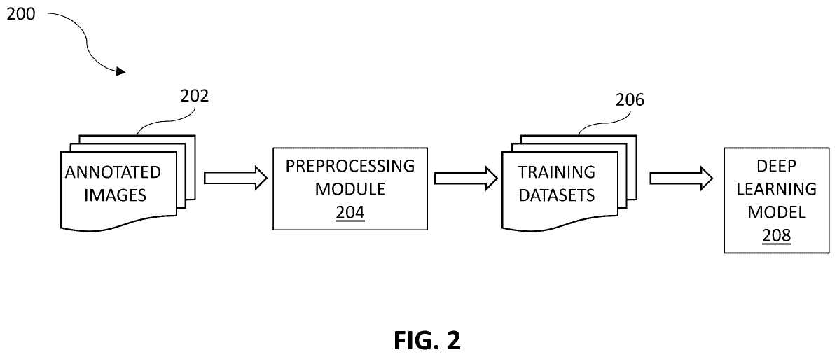

FIG. 2 illustrates a simplified block diagram of an example images segmentation system 200 in accordance with features of embodiments described herein. As shown in FIG. 2, in system 200, annotated images 202, which may comprise label maps or other datasets, are input to a preprocessing module 204. As will be described in greater detail below, preprocessing module 204 processes the images 202 to adjust the resolution thereof (e.g., using down-sampling techniques) and create training datasets 206, which are used to train a deep learning model 208. In some embodiments, deep learning module comprises a CNN for performing image segmentation in connection with autonomous driving applications.

In particular embodiments, as will be described in greater detail below, preprocessing module 204 may perform image segmentation label expansion for select, particularly rare (e.g., FH and CT), classes to avoid the aforementioned issues associated with direct down-sampling. In this embodiment, a Gaussian filter may be applied on the one-hot labels to smooth scores across classes and per-class scores are weighted by an inverse of the frequency of the class, after which the score maps may be down-sampled to the required resolution. In alternative embodiments, as will also be described in greater detail below, preprocessing module may perform image segmentation label expansion using a dilation function applied once or numerous times to augment the label maps of select classes, such as FH and CT, for training.

### Example Techniques for Performing Image Segmentation Label Expansion

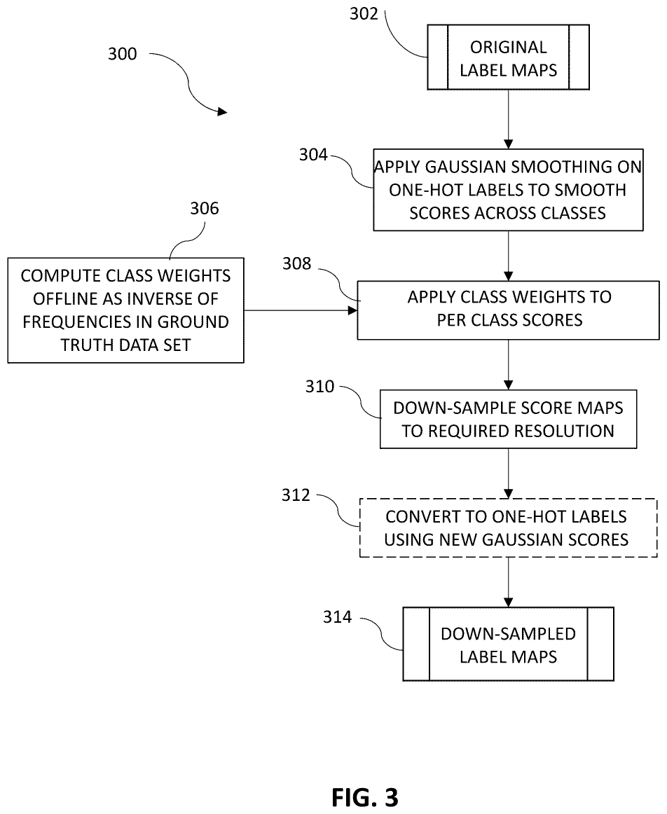

FIG. 3 illustrates a flow diagram 300 of example operations of an example technique for performing image segmentation label expansion for select classes using a smoothing filter, such as a Gaussian filter. In certain embodiments, one or more of the operations illustrated in FIG. 3 may be executed by one or more of the elements shown in FIGS. 1 and/or 2, for example. In particular embodiments, one or more of the operations of flow diagram 300 are implemented by preprocessing module 204.

At operation 304, Gaussian smoothing may be applied to one-hot labels of original label maps 302 to smooth scores across all classes. It will be recognized that the Gaussian smoothing performed in 304 may be accomplished using a Gaussian filter, or kernel. It will be further recognized that other smoothing filters may be applied without departing from the spirit or scope of embodiments described herein.

At operation 306, per-class weights may be computed offline. In particular embodiments, the weight of a class may be an inverse of the frequency of the class in the ground truth dataset 302. As a result, rare classes (i.e., classes that appear less frequently in the dataset) will be weighted more heavily than more common classes (i.e., classes that appear more frequently in the dataset). In particular, FH and CT classes have a lower frequency due in part to their rare occurrence and in part to the fact that the objects (and the corresponding labels) are long and narrow. Other rare and/or low frequency classes may include traffic light poles and downed electrical lines, for example. Additionally, classes of objects that tend to be small and/or have irregular boundaries may also be designated as rare for purposes of the label expansion techniques described herein.

At operation 308, the per class scores may be weighted using the corresponding class weights computed at operation 306. As discussed in connection with operation 306, rare classes are weighted more heavily than more common classes.

At operation 310, the (weighted) score maps may be down-sampled to the resolution required by the deep learning model (e.g., model 208).

At optional operation 312, the scores may be converted to one-hot labels. This step may be omitted in particular embodiments, in which case the Gaussian scores may be used directly instead.

At operation 314, the resulting down-sampled label maps (including either one-hot labels or Gaussian scores) may be output from the preprocessing module (e.g., preprocessing module 204) for use as testing datasets.

Although the operations of the example method shown in FIG. 3 are illustrated as occurring once each and in a particular order, it will be recognized that the operations may be performed in any suitable order and repeated as desired. Additionally, one or more operations may be performed in parallel. Furthermore, the operations illustrated in FIG. 3 may be combined or may include more or fewer details than described.

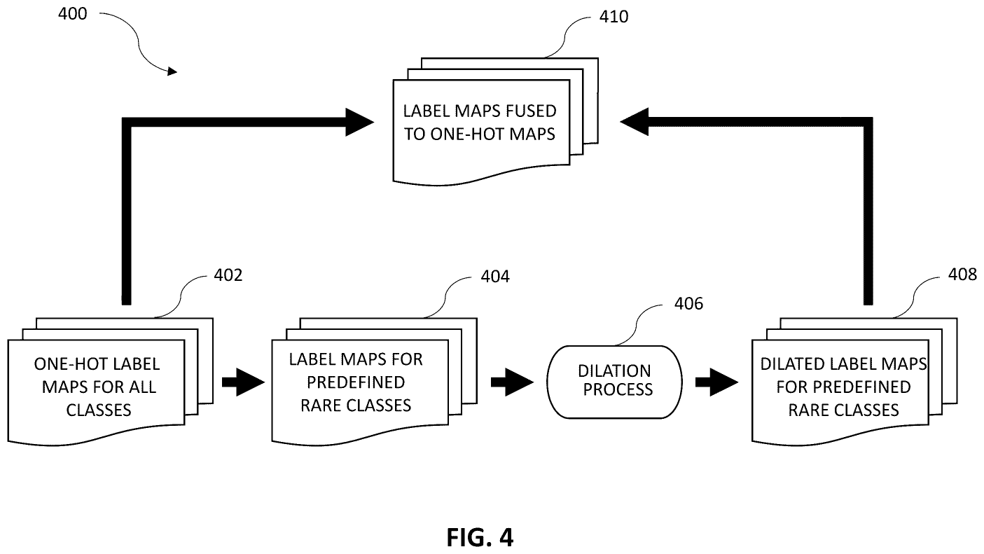

FIG. 4 illustrates a flow diagram 400 of example operations of an example technique for performing image segmentation label expansion for select classes using a dilation function. In certain embodiments, one or more of the operations illustrated in FIG. 4 may be executed by one or more of the elements shown in FIGS. 1 and/or 2, for example. In particular embodiments, one or more of the operations of flow diagram 400 are implemented by preprocessing module 204.

As shown in FIG. 4, in operation, one-hot label maps 402 are generated for all classes. Label maps for predefined rare classes (e.g., FH and CT) 404 are input to a dilation process 406 which generates dilated label maps for the predefined rare classes 408. The one-hot label maps for all classes 402 and the dilated label maps for predefined rare classes 408 are fused to new one-hot maps 410.

FIG. 5 illustrates an example process 500 performed by the dilation process 406 to dilate a label map for a predefined rare class. As shown in FIG. 5, a label map 502, which comprises an original human-labeled one-hot label map for one (rare) class is input to a dilation function 504. As shown in FIG. 5, dilation function 504 dilates the map 502 by adding 1s to create a dilated one-hot label map 506.

In particular embodiments, the dilation function 504 takes on a predefined label map (e.g., a mask) as input and sets the number of iterations to apply the dilation. The dilation function 504 outputs a dilated label map for the corresponding class. More specifically, in each iteration, a 3×3 kernel/sliding-window will scan the input one-hot label map 502 with stride 1. If there are any 1s in the 3×3 window, it will output 1 to the corresponding pixel of the output label map. The output label map will be used to update the input label map for the next iteration. After finishing all iterations, the dilation function 504 will return the final output label map 506.

Referring again to FIG. 4, all predefined label maps for rare classes in self.dilate_labels will pass to the dilation process and the resulting label map will be fused with the label maps of the rest of the classes. Mathematically, the one-hot label maps can be represented by a H×W×C matrix, where H and W are the height and width of the label maps and C is the number of classes. Each slice along the C dimension represents the one-hot label map for one class and there should only be one 1 along the C dimension. After applying the dilation on label maps for all predefined rare classes, there will be more than 1s in the C dimension, since dilation changes some 0s of the label map into 1s. Thus we need a fuse process to make sure that only one 1 in the C dimension. More specifically, we only keep the 1 in the last dilated label map, and reset the 1s of all other classes to 0s.

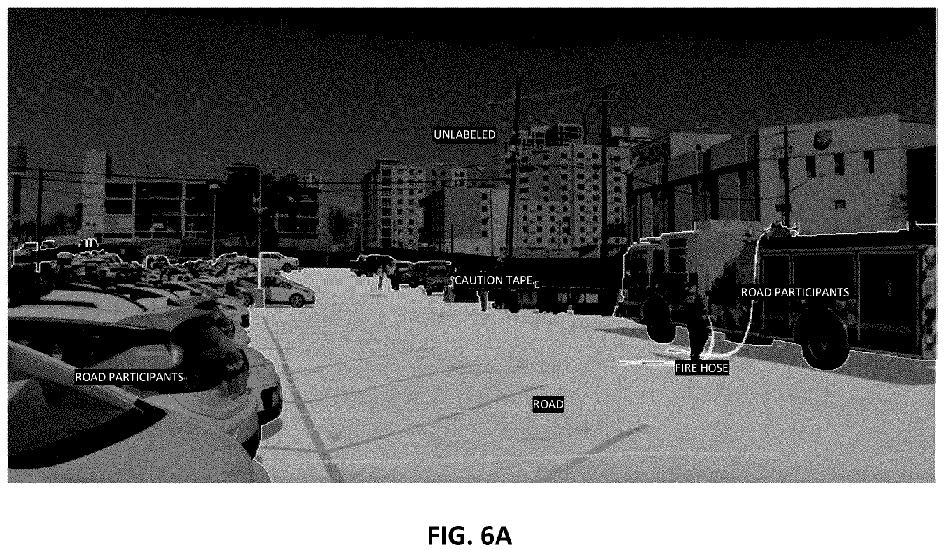

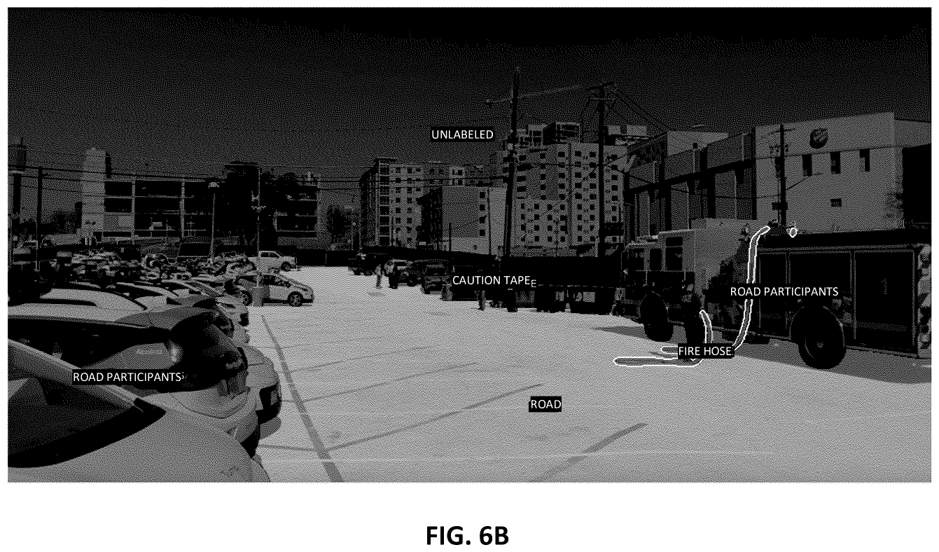

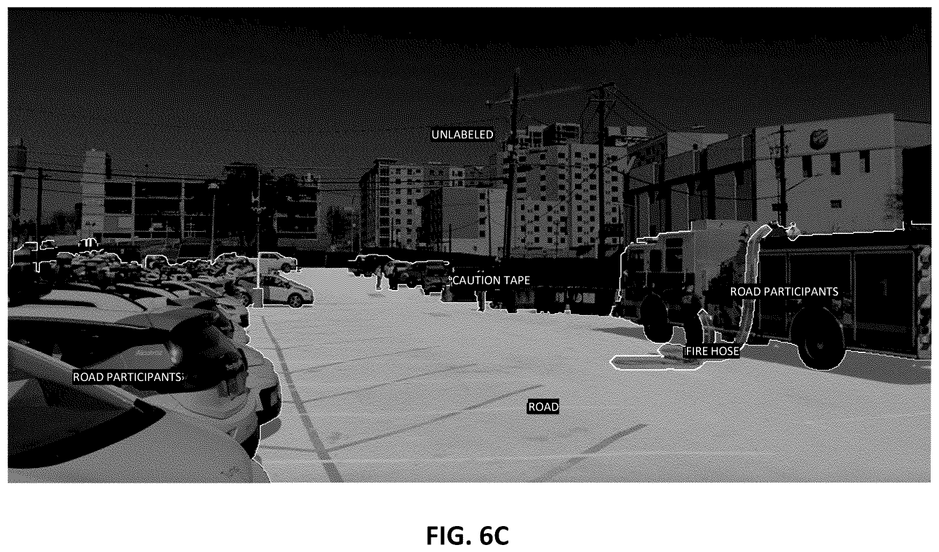

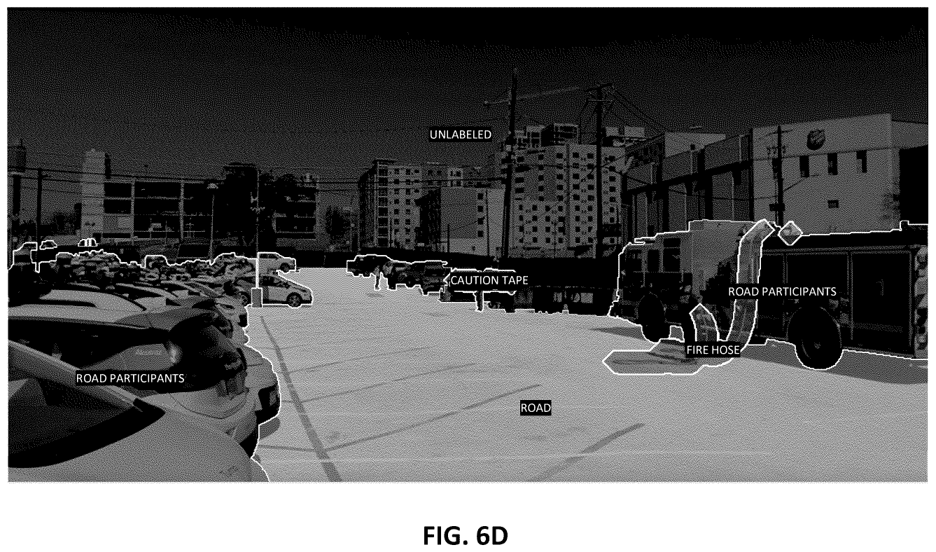

To increase the amount of dilation for each rare class, the dilation filter may be increased and/or the number of iterations of dilation may be increased. FIG. 6A illustrates a GT image in which no dilation has been performed. In contrast, FIGS. 6B, 6C, and 6D each illustrate the image shown in FIG. 6A after 5, 10, and 20 iterations of dilation have been performed, respectively, on the image for CT and FH classes. As is apparent from the images shown in FIGS. 6A-6D, no other classes have been dilated.

### Example Processor-Based System

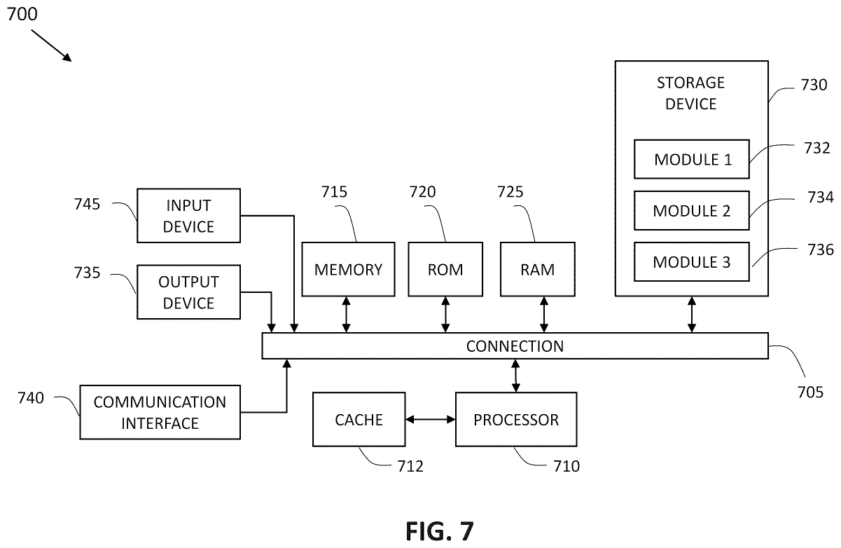

FIG. 7 illustrates an example processor-based system with which some aspects of the subject technology can be implemented. For example, processor-based system 700 can be any computing device making up, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (Central Processing Unit (CPU) or processor) 710 and connection 705 that couples various system components including system memory 715, such as Read-Only Memory (ROM) 720 and Random-Access Memory (RAM) 725 to processor 710. Computing system 700 can include a cache of high-speed memory 712 connected directly with, in close proximity to, or integrated as part of processor 710.

Processor 710 can include any general purpose processor and a hardware service or software service, such as services 732, 734, and 736 stored in storage device 730, configured to control processor 710 as well as a special purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a Bluetooth® wireless signal transfer, a Bluetooth® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 740 may also include one or more GNSS receivers or transceivers that are used to determine a location of the computing system 700 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory and/or computer-readable memory device and can be a hard disk or other types of computer-readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid state memory, a Compact Disc Read-Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Static RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 730 can include software services, servers, services, etc., that when the code that defines such software is executed by the processor 710, it causes the system 700 to perform a function. In some embodiments, a hardware service that performs a particular function can include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network personal computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Example 1 provides a method for facilitating image segmentation on a dataset including a plurality of classes, the method including preprocessing the dataset by applying a filter to labels of the plurality of classes to expand the labels of the selected class; and down-sampling the preprocessed dataset to a desired resolution for training an image segmentation model.

Example 2 provides the method of example 1, in which the labels include one-hot labels.

Example 3 provides the method of example 2, in which the filter includes a Gaussian smoothing filter and in which the preprocessing further includes applying the Gaussian smoothing filter to the one-hot labels to create corresponding Gaussian scores.

Example 4 provides the method of example 3, further including computing for each class of the plurality of classes a weight, in which for each class of the plurality of classes, the weight is an inverse of a frequency of the class in the dataset.

Example 5 provides the method of example 4, further including, for each class of the plurality of classes, applying the weight for the class to the corresponding Gaussian scores to create weighted Gaussian scores.

Example 6 provides the method of example 5, further including, subsequent to the down-sampling, converting the weighted Gaussian scores to updated one-hot labels.

Example 7 provides the method of any one of examples 1-6, in which the filter includes a dilation filter and in which the preprocessing further includes dilating a label map for a selected class of the plurality of classes to create a dilated label map for the selected class.

Example 8 provides the method of example 7, in which the selected class includes one of a firehose class, a caution tape class, an electrical line class, and a traffic light pole class.

Example 9 provides the method of example 7 or 8, further including fusing the dilated label map to label maps for remaining ones of the plurality of classes.

Example 10 provides the method of any one of examples 1-9, further including inputting the down-sampled preprocessed dataset to the image segmentation module.

Example 11 provides an apparatus for facilitating image segmentation on a dataset including a plurality of classes, the apparatus including a module executable by a processor to: preprocess the dataset by applying a filter to labels of the plurality of classes to expand the labels of the selected class; down-sample the preprocessed dataset to a desired resolution for training an image segmentation model; and output the down-sampled preprocessed dataset to the image segmentation module; in which the labels include one-hot labels.

Example 12 provides the apparatus of example 11, in which the filter includes a Gaussian smoothing filter and in which the preprocessing further includes applying the Gaussian smoothing filter to the one-hot labels to create corresponding Gaussian scores.

Example 13 provides the apparatus of example 12, in which for each class of the plurality of classes, a weight is computed and includes an inverse of a frequency of the class in the dataset.

Example 14 provides the apparatus of example 13, in which the module is further executable by the processor to: for each class of the plurality of classes, apply the weight for the class to the corresponding Gaussian scores to create weighted Gaussian scores; and subsequent to the down-sampling, convert the weighted Gaussian scores to updated one-hot labels.

Example 15 provides the apparatus of any one of examples 11-14, in which the filter includes a dilation filter and in which the preprocessing further includes dilating a label map for a selected class of the plurality of classes to create a dilated label map for the selected class, in which the dilated label map is fused to label maps for remaining ones of the plurality of classes prior to the down-sampled preprocessed dataset being output to the image segmentation module.

Example 16 provides one or more non-transitory computer-readable media storing instructions that when executed by a computer cause the computer to perform operations including preprocessing the dataset by applying a filter to labels of the plurality of classes to expand the labels of the selected class; down-sampling the preprocessed dataset to a desired resolution for training an image segmentation model; and outputting the down-sampled preprocessed dataset to the image segmentation module; in which the labels include one-hot labels.

Example 17 provides the one or more non-transitory computer-readable media of example 16, in which the filter includes a Gaussian smoothing filter and in which the preprocessing further includes applying the Gaussian smoothing filter to the one-hot labels to create corresponding Gaussian scores.

Example 18 provides the one or more non-transitory computer-readable media of example 17, in which the operations further include, for each class of the plurality of classes, computing a weight for the class, in which the weight for the class includes an inverse of a frequency of the class in the dataset.

Example 19 provides the one or more non-transitory computer-readable media of example 18, in which the operations further include for each class of the plurality of classes, applying the weight for the class to the corresponding Gaussian scores to create weighted Gaussian scores; and subsequently to the down-sampling, converting the weighted Gaussian scores to updated one-hot labels.

Example 20 provides the one or more non-transitory computer-readable media of any one of examples 16-19, in which the filter includes a dilation filter and in which the preprocessing further includes dilating a label map for a selected class of the plurality of classes to create a dilated label map for the selected class, in which the dilated label map is fused to label maps for remaining ones of the plurality of classes prior to the down-sampled preprocessed dataset being output to the image segmentation module.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the interior electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as exterior storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended examples. The specifications apply only to one non-limiting example and, accordingly, they should be construed as such. In the foregoing description, example embodiments have been described with reference to particular arrangements of components. Various modifications and changes may be made to such embodiments without departing from the scope of the appended examples. The description and drawings are, accordingly, to be regarded in an illustrative rather than in a restrictive sense.

Note that with the numerous examples provided herein, interaction may be described in terms of two, three, four, or more components; however, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification.

Various operations may be described as multiple discrete actions or operations in turn in a manner that is most helpful in understanding the example subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended examples. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the examples appended hereto, Applicant wishes to note that the Applicant: (a) does not intend any of the appended examples to invoke paragraph (f) of 35 U.S.C. Section 112 as it exists on the date of the filing hereof unless the words “means for” or “step for” are specifically used in the particular examples; and (b) does not intend, by any statement in the Specification, to limit this disclosure in any way that is not otherwise reflected in the appended examples.

What is claimed is:

1. An apparatus for facilitating image segmentation on a dataset comprising a plurality of classes, the apparatus comprising:
a module executable by a processor to:
preprocess the dataset by applying a filter to labels of the plurality of classes to expand the labels of the selected class;
down-sample the preprocessed dataset to a desired resolution for training an image segmentation model; and
output the down-sampled preprocessed dataset to the image segmentation module;
wherein the labels comprise one-hot labels.

2. The apparatus of claim 1, wherein the filter comprises a Gaussian smoothing filter and wherein the preprocessing further comprises applying the Gaussian smoothing filter to the one-hot labels to create corresponding Gaussian scores.

3. The apparatus of claim 2, wherein for each class of the plurality of classes, a weight is computed and comprises an inverse of a frequency of the class in the dataset.

4. The apparatus of claim 3, wherein the module is further executable by the processor to:
for each class of the plurality of classes, apply the weight for the class to the corresponding Gaussian scores to create weighted Gaussian scores; and
subsequent to the down-sampling, convert the weighted Gaussian scores to updated one-hot labels.

5. The apparatus of claim 1, wherein the filter comprises a dilation filter and wherein the preprocessing further comprises dilating a label map for a selected class of the plurality of classes to create a dilated label map for the selected class, wherein the dilated label map is fused to label maps for remaining ones of the plurality of classes prior to the down-sampled preprocessed dataset being output to the image segmentation module.

6. One or more non-transitory computer-readable media storing instructions that when executed by a computer cause the computer to perform operations comprising:
preprocessing the dataset by applying a filter to labels of the plurality of classes to expand the labels of the selected class;
down-sampling the preprocessed dataset to a desired resolution for training an image segmentation model; and
outputting the down-sampled preprocessed dataset to the image segmentation module;
wherein the labels comprise one-hot labels.

7. The one or more non-transitory computer-readable media of claim 6, wherein the filter comprises a Gaussian smoothing filter and wherein the preprocessing further comprises applying the Gaussian smoothing filter to the one-hot labels to create corresponding Gaussian scores.

8. The one or more non-transitory computer-readable media of claim 7, wherein the operations further comprise, for each class of the plurality of classes, computing a weight for the class, wherein the weight for the class comprises an inverse of a frequency of the class in the dataset.

9. The one or more non-transitory computer-readable media of claim 8, wherein the operations further comprise:
for each class of the plurality of classes, applying the weight for the class to the corresponding Gaussian scores to create weighted Gaussian scores; and
subsequently to the down-sampling, converting the weighted Gaussian scores to updated one-hot labels.

10. The one or more non-transitory computer-readable media of claim 6, wherein the filter comprises a dilation filter and wherein the preprocessing further comprises dilating a label map for a selected class of the plurality of classes to create a dilated label map for the selected class, wherein the dilated label map is fused to label maps for remaining ones of the plurality of classes prior to the down-sampled preprocessed dataset being output to the image segmentation module.

11. A method for facilitating image segmentation on a dataset comprising a plurality of classes, the method comprising:
preprocessing the dataset by applying a filter to labels of the plurality of classes to expand the labels of the selected class; and
down-sampling the preprocessed dataset to a desired resolution for training an image segmentation model.

12. The method of claim 11, wherein the labels comprise one-hot labels.

13. The method of claim 12, wherein the filter comprises a Gaussian smoothing filter and wherein the preprocessing further comprises applying the Gaussian smoothing filter to the one-hot labels to create corresponding Gaussian scores.

14. The method of claim 13, further comprising computing for each class of the plurality of classes a weight, wherein for each class of the plurality of classes, the weight is an inverse of a frequency of the class in the dataset.

15. The method of claim 14, further comprising, for each class of the plurality of classes, applying the weight for the class to the corresponding Gaussian scores to create weighted Gaussian scores.

16. The method of claim 15, further comprising, subsequent to the down-sampling, converting the weighted Gaussian scores to updated one-hot labels.

17. The method of claim 11, wherein the filter comprises a dilation filter and wherein the preprocessing further comprises dilating a label map for a selected class of the plurality of classes to create a dilated label map for the selected class.

18. The method of claim 17, wherein the selected class comprises one of a firehose class, a caution tape class, an electrical line class, and a traffic light pole class.

19. The method of claim 17, further comprising fusing the dilated label map to label maps for remaining ones of the plurality of classes.

20. The method of claim 11, further comprising inputting the down-sampled preprocessed dataset to the image segmentation module.
